(19) United States
(12) Patent Application Publication
(10) Pub. No.: US 2013/0330528 A1
(43) Pub. Date: Dec. 12, 2013

(54) FLOOR COVERING

(71) Applicants: Uwe Keller, Oberhausen-Rheinhausen (DE); Gregor Grun, Zweibrucken (DE); Alfons Butscher, Birkenau (DE)

(72) Inventors: Uwe Keller, Oberhausen-Rheinhausen (DE); Gregor Grun, Zweibrucken (DE); Alfons Butscher, Birkenau (DE)

(73) Assignee: NORA SYSTEMS GMBH, WEINHEIM (DE)

(21) Appl. No.: 14/000,915

(22) PCT Filed: Jan. 17, 2012
(86) PCT No.: PCT/EP12/00176

§ 371 Date: Aug. 22, 2013

(30) Foreign Application Priority Data
Feb. 23, 2011 (DE) 10 2011 012 169.2

(51) Int. Cl. E04F 15/10; B32B 37/14

(52) U.S. Cl. CPC E04F 15/107; B32B 37/14
USPC 428/212; 156/60

(57) ABSTRACT

A floor covering comprising a first layer of elastomeric material and a second layer of elastomeric material. Both of the first and second layers being provided with fillers, where the fillers are chosen in such a way that, when subjected to a temperature change, the second layer has a greater coefficient of expansion at least in one direction than the first layer. A further layer is arranged between the first layer and the second layer.

The invention relates to a floor covering of elastomeric material and to a method for the production thereof.

Floor coverings of elastomeric materials are usually produced in tile form, for example as square panels, with an edge length of 50 cm or 1 m. On account of the material properties of the elastomer, such floor coverings have significant temperature-dependent dimensional changes in the unbonded, loosely laid state. For the elastomeric materials that are frequently used in elastomeric floor coverings, styrene, butadiene, rubber and nitro-butadiene rubber, the coefficients of thermal expansion lie for example at approximately 0.02% per degree of temperature change. Such a coefficient of expansion has the effect that, when subjected to a temperature change of 10° Celsius, a tile of an elastomeric floor covering with an edge length of 1 meter undergoes a change in length of over 1.5 mm. For this reason, it is necessary to adhesively bond elastomeric floor coverings to the base during laying, in order to obtain a uniform surface without gaps or tenting seams. Usually a pasty adhesive is used for the adhesive bonding and is applied to the full surface area of the base or the floor covering tiles.

However, adhesively bonding a floor covering over its full surface area is laborious and, depending on the base, possibly requires the use of a toxic adhesive. Furthermore, bases on which adhesive bonding is not possible at all are conceivable.

The invention is based on the object of providing a floor covering of elastomeric material that can be laid without being adhesively bonded.

This object is achieved by the features of claims 1 and 9. The subclaims respectively refer to advantageous configurations.

To achieve the object, the floor covering comprises a first layer of elastomeric material and a second layer of elastomeric material, both layers being provided with fillers. The fillers in the two layers are chosen in such a way that, when subjected to a temperature change, the second layer has a greater coefficient of expansion in at least one direction than the first layer, and a further layer being arranged between the first layer and the second layer. The area distribution of the fillers preferably produces a different coefficient of expansion between the first layer and the second layer in the direction of all the edges, that is to say in all the principal directions of the floor covering. On account of the solid bond between the first and second layers, the cooling of the floor covering following vulcanization produces a prestressing in its interior, which has the effect that the edges of the floor covering or of the floor covering tiles are bent slightly downward, i.e. in the direction of the base, as in the case of a bimetal. As a result, the floor covering lies on the base over virtually its full surface area.

The further layer arranged between the two layers is formed such that it has a temperature-dependent coefficient of expansion that is as low as possible. The solid bonding of the further layer between the first layer and the second layer also has the effect that the floor covering as a whole is dimensionally stable under temperature changes.

In a preferred configuration, the further layer consists of a textile fabric. Such a textile fabric may consist of a nonwoven, a laid or woven structure or a mixed form of the aforementioned. Fibers of polymeric materials or glass fibers preferably come into consideration as the material for the textile fabric. The textile fabric can be solidly bonded into the matrix of the floor covering by simple means, for example by means of vulcanization or by means of adhesion, so that it limits the expansion of the first layer and the second layer and thus ensures the dimensional stability of the floor covering as a whole.

Suitable as the elastomeric base material are all elastomers that are suitable for use as a floor covering. The base material preferably comprises the elastomers styrene-butadiene rubber (SBR), nitrile-butadiene rubber (NBR), ethylene-propylene rubber (EPM), ethylene-propylene-diene rubber (EPDM), ethylene-vinyl acetate (EVA), chlorosulfonyl-polyethylene rubber (CSM), silicone rubber (VSI) and/or ethylene-acrylate rubber (AEM), not only sulfur-crosslinked but also peroxide-crosslinked and addition-crosslinked. Mixtures of the elastomers mentioned may also be used.

The further layer preferably comprises a nonwoven.

Polyester comes into consideration in particular as the material for the nonwoven. Nonwovens are on the one hand available at low cost and on the other hand can be formed such that the coefficient of expansion of the nonwoven is directionally unbound, which means that the nonwoven has an identical coefficient of expansion over the surface area considered in every direction. As a result, the floor covering in which the further layer is bonded also correspondingly has an identical coefficient of expansion in all directions. In this connection, a thermally bonded spunlaid nonwoven is particularly advantageous, because it has a particularly uniform coefficient of expansion, is particularly stable and is suitable for processing in elastomer-processing machines.

With particular preference, the filler contains platelet-shaped particles. Platelet-shaped particles are characterized in that they are formed flat and that their height is less than their length and width. Chips or lamellar particles, for example, are of such a platelet shape. The platelet-shaped particles orient themselves during the processing of the layers, in particular during the calendering or during the flowing of the elastomeric raw material, which has the effect that the platelet-shaped particles are solidly bonded into the layers, impede one another during the cooling of the layer, but at the same time cannot evade one another, and thus limit the decrease in length of the layer. This advantageous effect is obtained in particular whenever the ratio of length to height (aspect ratio) of the platelet-shaped particles is at least 10:1.

The platelet-shaped particles may comprise sheet silicate, in particular kaolin and/or mica. Sheet silicate have a layered structure, which makes it possible to produce particularly flat fillers in platelet shape, having a great difference between length and height (aspect ratio). In addition, kaolin and mica in particular are already known in a large number of industrial applications.

The previously mentioned platelet-shaped particles then advantageously have an effect according to the invention if the first layer has a greater amount of the first constituent of the filler than the second layer, the proportion by weight, based on the respective layer, of the first constituent of the filler of the first layer preferably being at least 10% greater than that of the second layer. With this quantitative ratio, it is ensured that a sufficiently great prestressing forms within the floor covering, by which the covering lies on the base over virtually its full surface area without the edges rising up.

According to the inventive method for producing a floor covering, a first layer is produced with a first amount of fillers, a second layer is produced with a second amount of fillers, a further layer is arranged between the first layer and the second layer and the layers are materially bonded to one another. According to the invention, two layers with amounts of fillers that differ from one another are provided, the layers having a different coefficient of expansion as a result. The further layer arranged between the two layers, preferably a textile fabric, has the effect that the temperature-dependent expansion of the floor covering as a whole is limited.

To form the elastomeric properties, the layers may be subjected to a vulcanization process. In this connection it is advantageous to subject the layers to a joint vulcanization process, in order that the layers are additionally materially bonded to one another. The vulcanization process is a combined heat and pressure treatment of the raw material forming the floor covering, whereby the first layer and the second layer on the one hand obtain the rubber-elastic properties and on the other hand the layers are penetrated at the surfaces that are in contact with one another by the material of the other layer, respectively, whereby a particularly solid material bond is obtained. Against this background, the forming of the further layer from a nonwoven is particularly advantageous in particular. On account of the non-closed matrix of the nonwoven, the material of the first layer and of the second layer penetrates into the matrix of the nonwoven during the vulcanization process and a particularly solid material bond is obtained. To this extent, in the case of this method the further layer is vulcanized onto the layers.

However, it is also conceivable to materially bond the further layer to the first layer and the second layer by means of adhesion. This is advantageous in particular whenever the first and/or the second layer does not require a vulcanization process or this process has already been completed.

The floor covering configured according to the invention can be simply laid onto the base without any binder. In particular when the floor covering takes the form of tiles, it is also not necessary to join the individual tiles of the floor covering to one another.

The tiles of the floor covering are laid next to one another on the base and form an interlocking bond, it being ensured by the prestressing within the material of the floor covering that the edges of the individual tiles of the floor covering do not rise up.

Furthermore, it is ensured on account of the further layer that the coefficient of expansion of the tiles is so limited that no gaps between the tiles form either.

In a particularly preferred laying method, firstly tiles of a floor covering are provided, subsequently the tiles are provided on the side facing the base with a double-sided adhesive tape and are laid onto the base. It is in this case preferably provided that only the edge regions of the individual tiles or else only the regions of the individual tiles assigned to the corners are provided with the adhesive tape. The double-sided adhesive tape is preferably formed such that it provides a strong adhesive effect in the direction of the floor covering and provides only a weak adhesive effect in the direction of the base. Accordingly, the adhesive effect of the double-sided adhesive tape is weaker with respect to the base than with respect to the tiles of the floor covering. As a result it is possible to easily remove the floor covering again at any time. In a further advantageous configuration, instead of an adhesive tape, adhesive tags are adhesively attached in the corner regions of the tiles, the weak adhesive effect of the tags being directed toward the base. This has the advantage that they are repeatedly reusable, whereby the floor covering tiles provided with such tags are suitable in particular for exhibition stand construction or on false floors.

An exemplary embodiment of the floor covering according to the invention is explained in more detail below on the basis of the figure, in which:

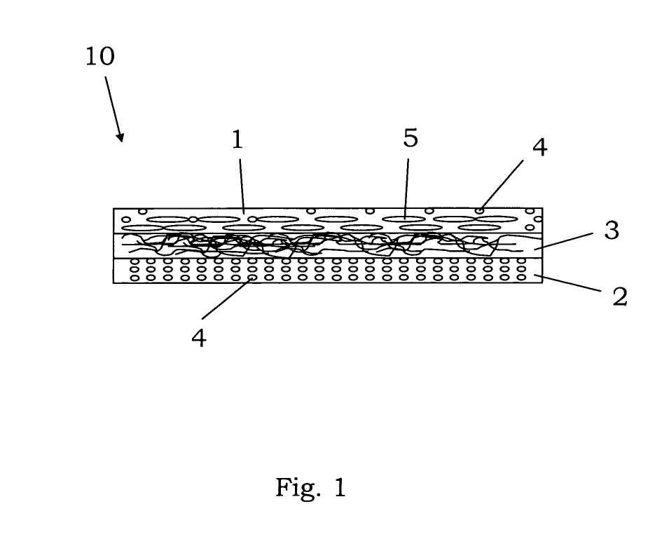

FIG. 1 schematically shows a multilayered floor covering.

FIG. 1 shows a multilayered elastomeric floor covering 10. A first layer 1 consists of elastomeric material based on styrene-butadiene rubber (SBR) and is provided with fillers 4. The fillers 4 contain particles 5 in platelet shape, at least some of which are formed from mica. In this case, the particles 5 in platelet shape are formed in such a way that the ratio of length to height (aspect ratio) is at least 10:1. In a further configuration, the first constituent consists of likewise lamellar kaolin or of a combination of kaolin and mica. The second layer 2 is likewise based on styrene-butadiene rubber (SBR) and is likewise provided with fillers 4, but no significant amount of particles 5 in platelet shape is provided in the second layer 2. This choice of the filler 4 according to the invention has the effect that, when subjected to a temperature change, the second layer 2 has a greater coefficient of expansion than the first layer 1, so that a prestressing is obtained within the floor covering 10, with the effect that, in particular when the floor covering 10 is configured as tiles, the floor covering curves in the direction of the edges, as in the case of a bimetal. This altogether has the effect of providing a curved floor covering 10, the edges of which in the unloaded state bend of their own accord in the direction of the base. When the floor covering 10 has been laid as intended on an base, the floor covering 10 extends along the base, the impeded bending in the interior of the floor covering 10 resulting in stresses that ensure that the floor covering 10 lies flat on the base. It is also conceivable that the second layer 2 also has platelet-shaped particles according to the first constituent 5. However, based on the respective layer, the proportion by weight of the particles 5 in platelet shape is according to the invention always lower in the second layer 2 than in the first layer 1, where the difference in weight should be at least 10%.

Arranged between the first layer 1 and the second layer is a further layer 3, which is formed from a thermally bonded polyester spunlaid nonwoven. A preferred weight per unit area of the polyester spunlaid nonwoven is between 100 and 200 g/m². The further layer 3 has a high tensile strength, both in the longitudinal direction and in the transverse direction. Furthermore, the further layer has a particularly low coefficient of expansion, so that, on account of the solid bonding of the further layer 3 into the matrix of the floor covering 10, the floor covering 10 as a whole also has only a low coefficient of expansion.

A floor covering according to the invention described by way of example has the following configuration:

The first layer 1 contains SBR, various fillers 4, the filler 4 containing particles 5 in platelet shape formed from mica. Furthermore, the fillers 4 contain a vulcanizing agent. The second layer 2 likewise contains SBR and various fillers 4, contained in which there is also a vulcanizing agent, but the fillers 4 that are provided for the second layer 2 do not contain any significant amount of particles 5 in platelet shape. The further layer 3 is formed from a thermally bonded polyester spunlaid nonwoven with a weight per unit area of 130 g/m².

To produce the floor covering 10, a first layer 1 with a first amount of fillers 4 is produced. In this case, the filler 4 that is provided for the first layer 1 is provided with a specific amount of particles 5 in platelet shape. Furthermore, a second layer 2 with a second amount of fillers 4 is produced, the filler 4 that is provided for the second layer 2 having no, or at least 10% fewer, particles 5 in platelet shape. A further layer 3 is provided and is arranged between the first layer 1 and the second layer 2. The further layer consists of a thermally bonded spunlaid nonwoven. Finally, the layers 1, 2, 3 are materially bonded to one another. The bonding is preferably performed by means of a vulcanization process, in which the layers 1, 2, 3 arranged one on top of the other in a sandwich-like manner are subjected to a combined heat and pressure treatment.

As a result, the rubber-elastic properties of the first layer 1 and of the second layer 2 evolve and the material of the first layer 1 and of the second layer 2 penetrates partially into the pores of the further layer 3, whereby a solid bond forms. As a result, the further layer 3 is vulcanized onto the first layer 1 and onto the second layer 2. In a further advantageous method, the further layer 3 is materially bonded to the first layer 1 and the second layer 2 by means of an adhesive layer. This is performed by means of an adhesive, which is respectively applied over the full surface area to at least one of the sides of the layers 1, 2, 3 that are in contact with one another. Here, too, the floor covering 10 may be additionally subjected to a heat and/or a pressure treatment.

In the case of a laying method according to the invention, firstly tiles of a floor covering are provided. Subsequently, the tiles are provided on the side facing the base with a double-sided adhesive tape or with adhesive tags in the regions of the edges and/or the corners and are subsequently laid next to one another onto the base. The double-sided adhesive tape is in this case formed such that it provides a stronger adhesive effect in the direction of the floor covering than in the direction of the base.

1. A floor covering comprising:
a first layer of elastomeric material and a second layer of elastomeric material, both layers being provided with fillers, the fillers in the two layers being chosen in such a way that, when subjected to a temperature change, the second layer has a greater coefficient of expansion at least in one direction than the first layer, and a further layer being arranged between the first layer and the second layer.

2. The floor covering as claimed in claim 1, wherein the further layer comprises a nonwoven.

3. The floor covering as claimed in claim 1 wherein the filler contains particles in platelet shape.

4. The floor covering as claimed in claim 3, wherein the particles in platelet shape have a ratio of length to height of at least 10:1.

5. The floor covering as claimed in claim 3, wherein the particles in platelet shape comprise at least one of kaolin and mica.

6. The floor covering as claimed in claim 1, wherein the fillers in the first layer have a greater amount of the particles in platelet shape than the second layer.

7. The floor covering as claimed in claim 6, wherein based on the respective layer, the proportion by weight of the particles in platelet shape of the first layer is at least 10% greater than that of the second layer.

8. A method for producing an elastomeric floor covering comprising the steps of:
producing a first layer with a first amount of fillers;
producing a second layer with a second amount of fillers;
arranging a further layer between the first layer and the second layer; and
materially bonding the first, second and further layers to one another.

9. The method as claimed in claim 8, the first, second and further layers are subjected to a vulcanization process.

10. The method as claimed in claim 8, wherein the further layer is vulcanized onto the first layer and the second layer.

11. The method as claimed in claim 8, wherein the further layer is materially bonded to the first layer and the second layer by means of an adhesive layer.
